(19) United States
(12) Patent Application Publication
(10) Pub. No.: US 2024/0184732 A1
(43) Pub. Date: Jun. 6, 2024

(54) MODULAR DATACENTER INTERCONNECTION SYSTEM

(71) Applicant: Enfabrica Corporation, Mountain View, CA (US)

(72) Inventors: David Skirmont, Mountain View, CA (US); Rochan Sankar, Mountain View, CA (US); Shrijeet Mukherjee, Mountain View, CA (US)

(21) Appl. No.: 18/526,727

(22) Filed: Dec. 1, 2023

Related U.S. Application Data
(60) Provisional application No. 63/429,683, filed on Dec. 2, 2022.

(51) Int. Cl. H05K 1/14

(52) U.S. Cl. CPC H05K 1/141; H05K 2201/04

(57) ABSTRACT

A modular interconnection system is disclosed. In some embodiments, the modular interconnection system comprising a server fabric adapter (SFA) on a primary circuit board, the SFA configured to perform peripheral component interconnect express (PCIe) interconnection or compute express link (CXL) interconnection; a plurality of ports on one or more PCIe slots configured to connect the SFA to external resources; and a PCIe slot adaptation device configured to adapt a first lane count slot of the one or more PCIe slots to support a second lane count device.

### CROSS REFERENCE TO RELATED APPLICATION

This application claims the benefit of U.S. Provisional Patent Application No. 63/429,683, titled “System and Method for a Modular Datacenter Interconnection System” and filed Dec. 2, 2022, the entire contents of which are incorporated by reference herein.

### TECHNICAL FIELD

This disclosure relates to a datacenter interconnection system that supports differing interconnection requirements through a modular design.

### BACKGROUND

The amount of data has drastically increased since the advent of artificial intelligence, machine learning, cloud computing, etc. This drastic data growth requires high-speed, high-bandwidth, low-latency solutions for seamless data processing by connected servers in datacenters. However, the interconnection between different types and quantities of computer resources may be limited by available network interface bandwidth, increased latency from multiple network hops, etc., causing the computer resources to be inefficiently shared across datacenters. Computer express link (CXL) can solve some of the interconnection problems, but it limits compute configuration at the level of server component, does not have a common allocation unit to adapt to different interconnection requirements, etc.

### SUMMARY

To address the aforementioned shortcomings, a modular interconnection system is provided. In some embodiments, A modular interconnection system is disclosed. In some embodiments, the modular interconnection system comprising a server fabric adapter (SFA) on a primary circuit board, the SFA configured to perform peripheral component interconnect express (PCIe) interconnection or compute express link (CXL) interconnection; a plurality of ports on one or more PCIe slots configured to connect the SFA to external resources; and a PCIe slot adaptation device configured to adapt a first lane count slot of the one or more PCIe slots to support a second lane count device.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an exemplary architecture of a modular interconnection system, according to some embodiments.

FIG. 2 illustrates an exemplary architecture of a modular interconnection system, according to other embodiments.

FIG. 3 illustrates an exemplary base board used in FIG. 2, according to some embodiments.

FIG. 4 illustrates an exemplary storage shelf containing enterprise and datacenter standard form factor (EDSFF) drives, according to some embodiments.

FIG. 5 illustrates an exemplary method for connecting a local central processing unit (CPU) to a server fabric adapter (SFA), according to some embodiments.

FIG. 6 illustrates an exemplary server fabric adapter architecture for accelerated and/or heterogeneous computing systems, according to some embodiments.

FIGS. 7A-7F illustrate block diagrams of an exemplary computer system with multiple PCIe slots and connectivity to the computer system via the PCIe slots, according to some embodiments.

FIG. 8 illustrates a block diagram of a PCIe slot adaptor of the present system, according to some embodiments.

FIG. 9 illustrates an example of a PCIe function, according to some embodiments.

FIG. 10 illustrates a block diagram of a PCIe slot adaptation device of the present system, according to some embodiments.

FIG. 11 illustrates an exemplary process for PCIe slot adaption, according to some embodiments.

FIG. 12 illustrates an exemplary process for PCIe slot adaption, according to other embodiments.

FIG. 13 illustrates an exemplary process for connecting a local host to an SFA, according to some embodiments.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Computer systems (e.g., servers) used in datacenters are mainly processor-centric. A server includes one or more central processing units (CPUs), and each CPU has direct access to its local memory (e.g., dynamic random access memory (DRAM)) and memory of the other processors in the same system. Such direct access can be a CPU-to-CPU interconnect, which is often vendor-specific. There are other types of connections to CPUs, e.g., based on peripheral component interconnect express (PCIe®). PCIe is a high-speed serial computer expansion bus standard. It is the common motherboard interface used to connect CPUs and peripheral hardware in the datacenter. For example, non-volatile memory express (NVMe®) drives, processing accelerators (e.g., graphics processing units (GPUs)) may be accessed through PCIe, and external network connections may be connected to CPUs using network interface cards (NICs) through PCIe. The types and quantities of the resources are configured at an individual server level that depends on expected workloads. Different computing workloads may require a different mixture of resources.

A datacenter includes large computer systems that are made up of hundreds or thousands of connected servers, and these servers are interconnected through network interfaces. The interconnection of servers in this manner has many shortcomings. For example, these connections may be limited by the available network interface bandwidth, incur latency penalties due to multiple network hops, rely on layered protocols to perform remote memory transactions, etc. As a result, memory and accelerator resources get stranded and cannot be efficiently shared across the datacenter.

Compute express link (CXL) is designed to address these issues. CXL is an open industry standard interconnect offering high-bandwidth, low-latency connectivity between a host processor and devices including accelerators, memory expansion, and smart I/O devices. CXL utilizes the PCIe 5.0 physical layer infrastructure and the PCIe alternate protocol to address the demanding needs of high-performance computational workloads in artificial intelligence, machine learning, communication systems, etc., through the enablement of coherency and memory semantics across heterogeneous processing and memory systems. In other words, CXL is a protocol that runs over a PCIe physical layer that allows a multitude of processors and peripherals to be interconnected. Devices that support CXL also support PCIe on the same interface and can be run simultaneously. For this reason, CXL and PCIe are used interchangeably throughout the present disclosure.

In general, CXL increases the effective locality of inter-server resources. The unit of compute configuration is no longer limited to a server. Instead, the resources can be disaggregated from their physical locations in a server chassis (e.g., external enclosure) to be made available to the whole datacenter.

When building a datacenter servers are added that often have a fixed configuration. CPU-related resources such as memory or GPUs are often a strict function of the number of servers. “X” servers (e.g., an unknown number of servers) may give too much memory or provide insufficient GPUs. The present system provides the unit of compute configuration at the level of server component, such that some number of server chassis, a different number of memory chassis, and another amount of storage may be added.

Server disaggregation allows for flexible allocation and balancing of compute resources, memory/storage, network resources, and accelerator resources. The variety of device types poses a challenge to a provider of CXL interconnection equipment, as there is no common allocation unit, both physically and logically. For example, unlike an Ethernet switch having a common port like RJ-45 or an octal small form factor pluggable (OSFP) connector, a CXL switch does not have a common form factor to enable a standard interface. A form factor defines mechanical attributes (e.g., length, thickness) for a family of devices. The present system provides a mechanism for the server equipment to adapt to many differing interconnection requirements.

Advantageously, the present system addresses the differing interconnection problem through a modular design. Servers are by their nature modular with bays for memory, NICs, and storage. Differing from prior systems, the present approach can be applied to a system for the interconnection of whole servers (not merely their internal components), memory/storage, and accelerators, and the disaggregation of those resources. Moreover, the present system removes the single CPU-connected NIC function to a pooled resource accessible to any of the devices in the CXL interconnection network.

### System Architecture

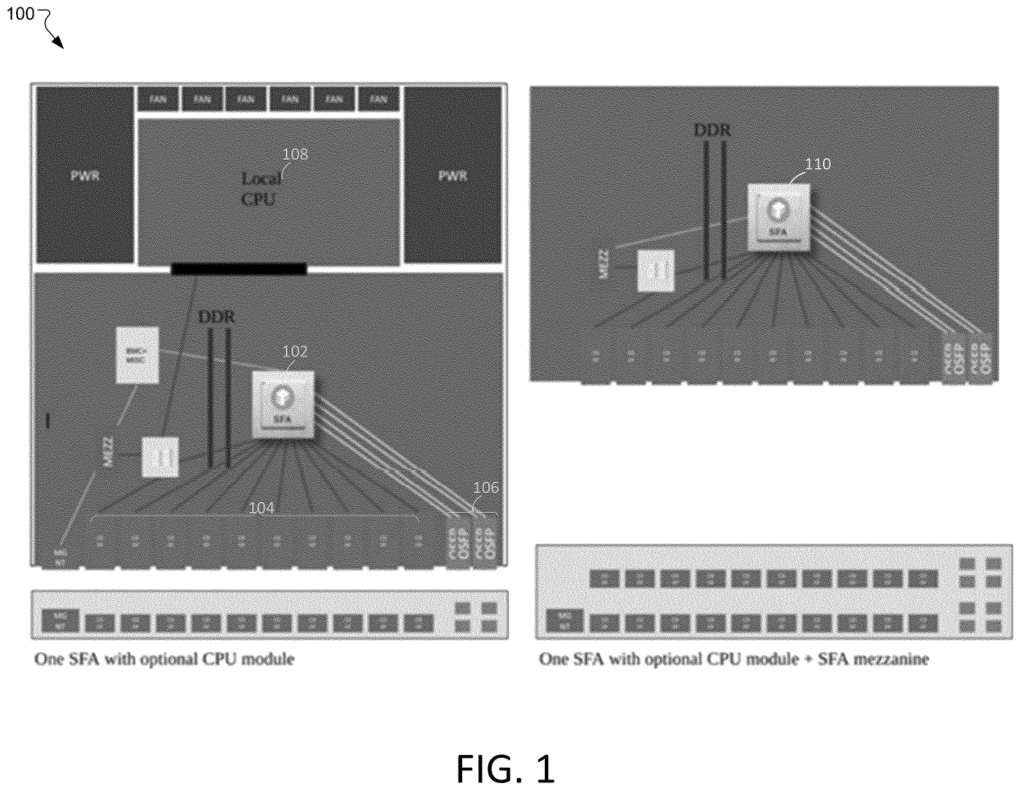

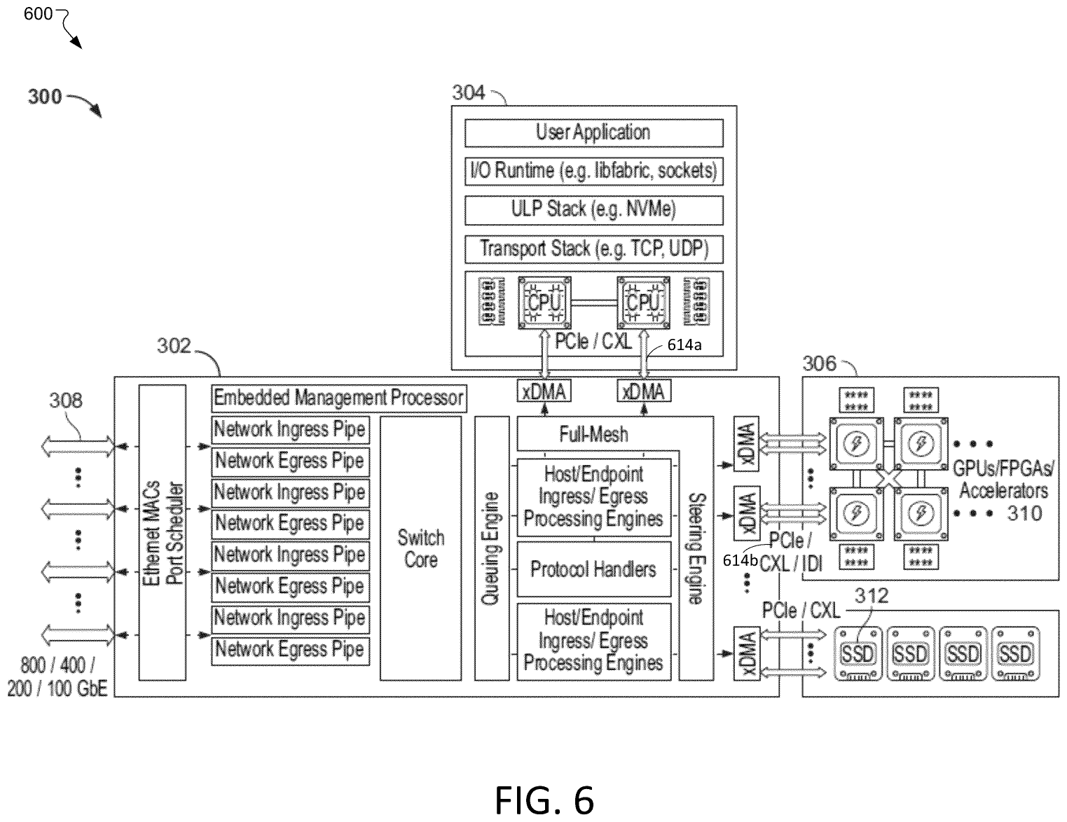

FIG. 1 illustrates an exemplary architecture of a modular interconnection system 100. In some embodiments, CXL interconnection can be performed by a server fabric adapter (SFA) 102, which will be described in detail below with reference to FIG. 6. In this example, SFA 102 has ten CXL ports for connection to servers, memory/storage, and/or accelerators. These can be 400 (CD=400 in Roman numerals) form factor pluggable (CDFP) ports 104 or similar modules for external connectivity. Additionally, in this example, there are four Ethernet network ports that are OSFPs 106. The connectivity to the OSFP cages is through flyover cables so that the OSFPs do not have to be on the same printed circuit board (PCB). It should be noted that although ten CXL ports and/or four Ethernet ports are included in this example, a person skilled in the art should recognize that any number of ports may be possible. System 100 also includes other components such as fans and power supplies.

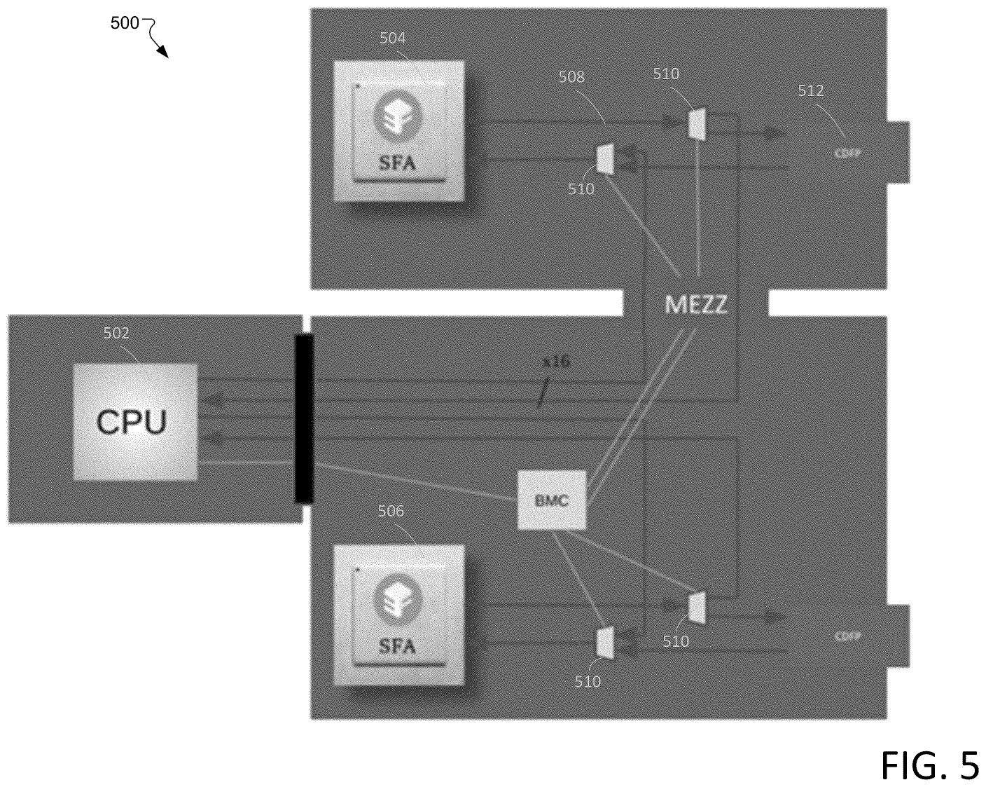

In FIG. 1, a local host/CPU 108, residing on a separate circuit board, acts as an infrastructure host. It can be connected to SFA 102 instead of one of the CDFP interfaces via a multiplexor (as described below in FIG. 5). Also shown is an option for a second SFA switch complex 110 residing on a mezzanine board. It shares common system resources with SFA 102 and is partially managed by the base board. SFA 110 also has the option of connecting to local CPU 108 in place of one of its CDFP ports.

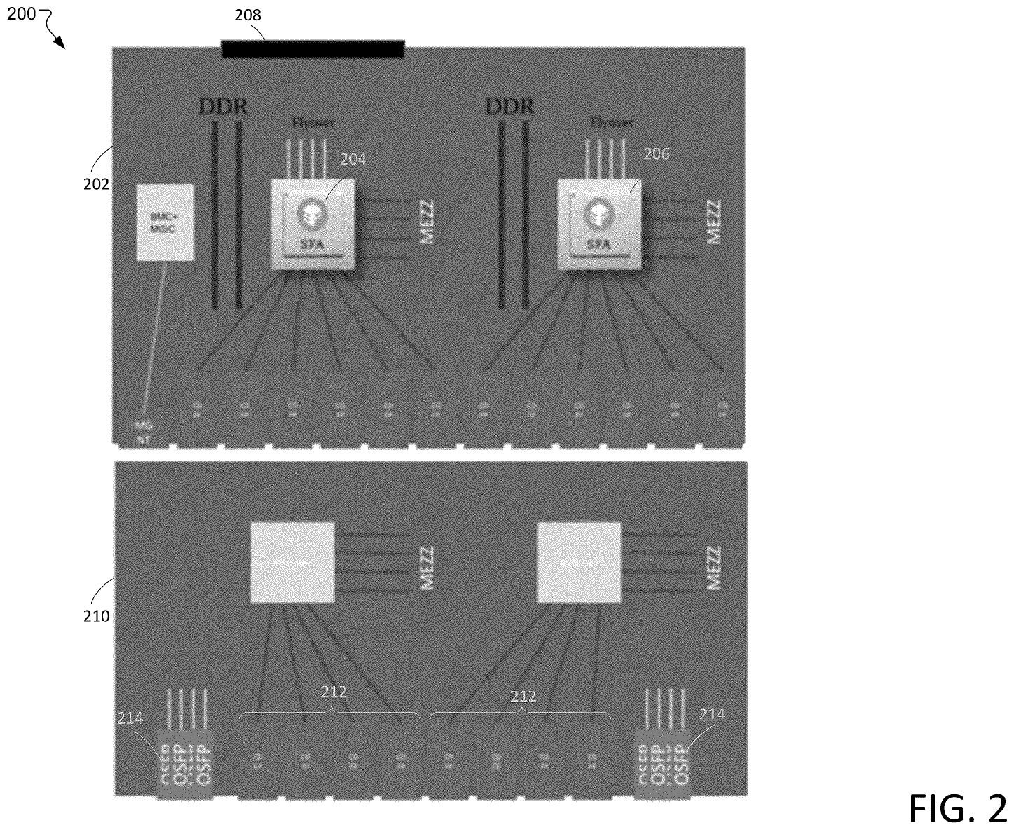

FIG. 2 illustrates another exemplary architecture of a modular interconnection system 200. In this example, base board 202 contains two SFA switch systems 204 and 206. There can also be an option of a local infrastructure host 208 as shown in FIG. 1. Each SFA 204 and 206 may have a portion of its CXL ports on base board 202 while including the rest of the ports on a mezzanine card 210 with additional ports. A mezzanine card is a printed circuit board assembly that is in a small and robust package to fit between two adjacent host cards in a standard card rack, attached to one of the cards by connectors and mounting pillars. Mezzanine card 210 in this example has CDFP ports 212. The Ethernet network connections via OSFP 214 are present on mezzanine card 210 but can be located anywhere in system 200.

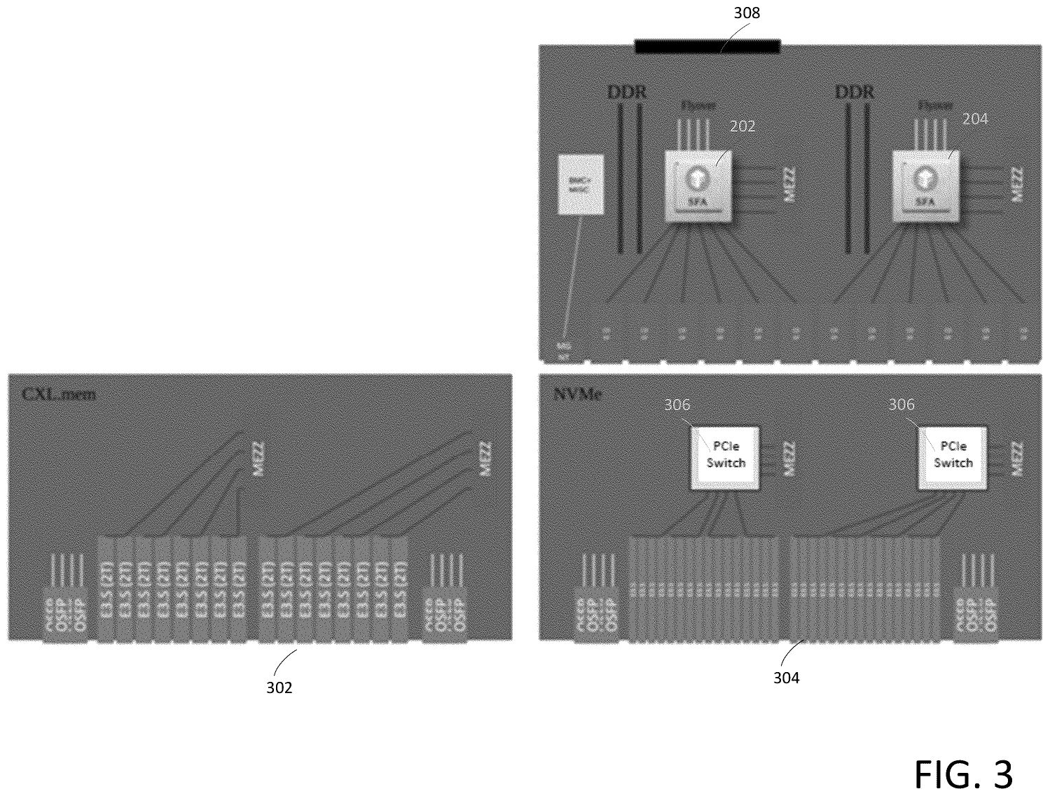

FIG. 3 illustrates an exemplary base board used in FIG. 2 with two different options for storage based mezzanine cards. In the example of FIG. 3, two storage mezzanine boards 302 and 304 are shown. Storage mezzanine board 302 contains EDSFF E3 short (E3.S) drives. Storage mezzanine board 304 includes EDSFF E1 short (E1.S) drives. A form factor (e.g., E1, E3) describes the physical aspects of a motherboard, specifying dimensions, power supplies, placement of mounting holes and ports, and other parameters. Enterprise and datacenter standard form factor (EDSFF) is a new storage form factor created to overcome the limitations of existing interfaces in a datacenter (e.g., currently more than one SSD form factor is required when multiple types of solid state drive are used for booting, performance or capacity).

In this example, the E1.S drives on board 304 are connected via a PCIe (e.g., CXL) switch 306 acting as a fanout and bifurcation device. In some embodiments, PCIe switch 306 is not strictly needed. Other implementations may have retimers or other signal-conditioning devices. In some embodiments, there may be a mix of EDSFF or other drive types. In other embodiments, there can also be a mix of EDSFF drives and CDFP-style modules for connection to external hosts. It should be noted that the base board can have any arbitrary number of SFA switches rather than merely the exemplary two SFA switch systems shown herein. A local CPU option 308 is also shown in the connector at the top of the base board.

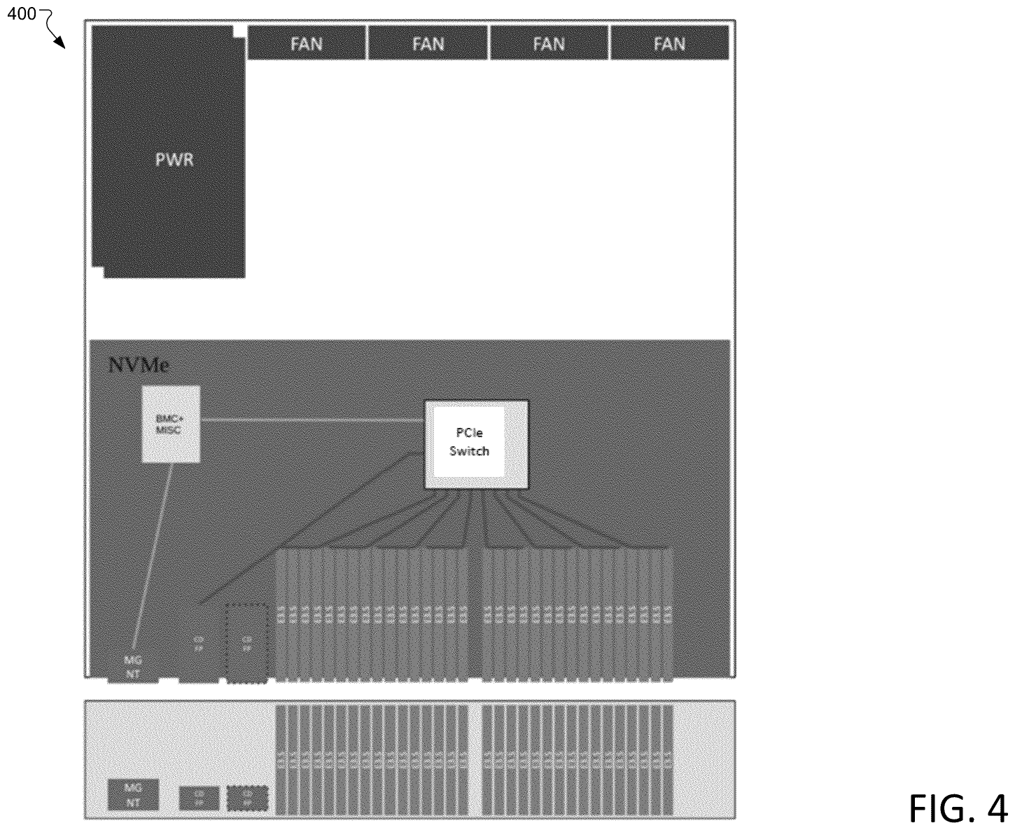

FIG. 4 illustrates an exemplary storage shelf 400 containing EDSFF drives, according to some embodiments. This storage shelf may expand the storage capability of the connection systems in FIG. 3, which may be limited in space. It is designed to be connected to the SFA switching systems in FIGS. 1 and 2. Other implementations support different drive form factors. There may also be variations with multiple host/switch side interfaces or differing amounts of fanout to drives/slots (not shown).

FIG. 5 illustrates an exemplary method 500 for connecting a local CPU to an SFA. Instead of having a direct connection to a CDFP or other types of CXL port, local CPU 502 is connected to SFA 504 or 506. In some embodiments, the PCIe lanes (e.g., 508) from a given SFA port (e.g., 504) can be directed to a multiplexer/demultiplexer (mux/demux) complex 510. The mux/demux complex 510 then connects the SFA port to either a physical connector (e.g., CDFP 512) or local infrastructure CPU 502. In some embodiments, mux/demux complex 510 may be controlled through software configuration via a baseboard management controller (BMC) or other configuration mechanisms. Either an SFA (504 or 506), both SFAs, or none of the SFA may be configured for a connection with local CPU 502 at a given time.

### Implementation System

FIG. 6 illustrates an exemplary server fabric adapter architecture 600 for accelerated and/or heterogeneous computing systems in a datacenter network. The server fabric adapter (SFA) 602 of FIG. 6 may be used to implement the architecture and processes described in FIGS. 1-5. In some embodiments, SFA 602 may connect to one or more controlling hosts 604, one or more endpoints 606, and one or more Ethernet ports 608. An endpoint 606 may be xPUs (e.g., GPUs, accelerators, FPGAs, etc.). Endpoint 606 may also be a storage or memory element 612 (e.g., SSD), etc. SFA 602 may communicate with the other portions of the datacenter network via the one or more Ethernet ports 608.

In some embodiments, the interfaces between SFA 602 and controlling host CPUs 604 and endpoints 606 are shown as over PCIe/CXL 614a or similar memory-mapped I/O interfaces. In addition to PCIe/CXL, SFA 602 may also communicate with a GPU/FPGA/accelerator 610 using wide and parallel inter-die interfaces (IDI) such as Just a Bunch of Wires (JBOW). The interfaces between SFA 602 and GPU/FPGA/accelerator 610 are therefore shown as over PCIe/CXL/IDI 614b.

SFA 602 is a scalable and disaggregated I/O hub, which may deliver multiple terabits-per-second of high-speed server I/O and network throughput across a composable and accelerated compute system. In some embodiments, SFA 602 may enable uniform, performant, and elastic scale-up and scale-out of heterogeneous resources. SFA 602 may also provide an open, high-performance, and standard-based interconnect (e.g., 800/400 GbE, PCIe Gen 5/6, CXL). SFA 602 may further allow I/O transport and upper layer processing under the full control of an externally controlled transport processor. In many scenarios, SFA 602 may use the native networking stack of a transport host and enable ganging/grouping of the transport processors (e.g., of x86 architecture).

As depicted in FIG. 6, SFA 602 connects to one or more controlling host CPUs 604, endpoints 606, and Ethernet ports 608. A controlling host CPU or controlling host 604 may provide transport and upper layer protocol processing, act as a user application “Master,” and provide infrastructure layer services. An endpoint 606 (e.g., GPU/FPGA/accelerator 610, storage 612) may be the producers and consumers of streaming data payloads that are contained in communication packets. An Ethernet port 608 is a switched, routed, and/or load-balanced interface that connects SFA 602 to the next tier of network switching and/or routing nodes in the datacenter infrastructure.

In some embodiments, SFA 602 is responsible for transmitting data at high throughput and low predictable latency between:
Network and Host;
Network and Accelerator;
Accelerator and Host;
Accelerator and Accelerator; and/or
Network and Network.

In general, when transmitting data/packets between the entities, SFA 602 may separate/parse arbitrary portions of a network packet and map each portion of the packet to a separate device PCIe address space. In some embodiments, an arbitrary portion of the network packet may be a transport header, an upper layer protocol (ULP) header, or a payload. SFA 602 is able to transmit each portion of the network packet over an arbitrary number of disjoint physical interfaces toward separate memory subsystems or even separate compute (e.g., CPU/GPU) subsystems.

By identifying, separating, and transmitting arbitrary portions of a network packet to separate memory/compute subsystems, SFA 602 may promote the aggregate packet data movement capacity of a network interface into heterogeneous systems consisting of CPUs, GPUs/FPGAs/accelerators, and storage/memory. SFA 602 may also factor, in the various physical interfaces, capacity attributes (e.g., bandwidth) of each such heterogeneous system/computing component.

In some embodiments, SFA 602 may interact with or act as a memory manager. SFA 602 provides virtual memory management for every device that connects to SFA 602. This allows SFA 602 to use processors and memories attached to it to create arbitrary data processing pipelines, load balanced data flows, and channel transactions towards multiple redundant computers or accelerators that connect to SFA 602. Moreover, the dynamic nature of the memory space associations performed by SFA 602 may allow for highly powerful failover system attributes for the processing elements that deal with the connectivity and protocol stacks of system 600.

### PCIe Slot Adaption

Different compute workloads require different compute resources such as NVMe drives, NICs, GPUs, etc. PCIe/CXL slots are used to add these resources (e.g., expansion cards/devices/equipment) to a baseboard to provide different functionality. However, as discussed above, PCIe/CXL does not have a physically or logically common allocation unit (e.g., no common port like RJ-45 or OSFP), this poses challenges to adapting a server to differing interconnection requirements when more expansion cards need to be added to a limited number of PCIe slots.

The present PCIe slot adaption method allows a drive slot (e.g., E3.S slot) to be adapted for use as another drive type. Advantageously, the present PCIe slot adaption method may change the supported lane width, unlike a PCIe splitter that may increase the number of PCIe slots but cannot add extra lanes of bandwidth. Additionally or alternatively, the present method can be used as an expansion slot containing other logic or an external connector.

Computer systems commonly employ PCIe as an interconnection facility between components and cards. PCIe allows for links of 1, 2, 4, 8, and 16 lanes. A PCIe lane is the path/connection through which data is transported to and from a slot and a CPU. The more PCIe lanes a slot has, the higher its throughput rate (speed) and the more demanding expansion cards it can support. The number of lanes needed is determined by the bandwidth requirements of a given use case. CPUs have limitations on the number of ports and lanes that can be supported. Generally, the number of lanes is a function of physical size, available pins, power, cost, PCB routing channels, and other factors. Equipment using PCIe is often optimized for a specific use case such as storage, NIC, external connectivity, or GPU. PCIe expansion slots are therefore usually limited to just the number of lanes needed for that use case.

Storage devices commonly have no more than four lanes per slot (e.g., x4). Newer types of storage may use eight lanes (e.g., x8). GPUs and NICs typically use 16 lanes (e.g., x16). PCIe is cross and backward-compatible of different slots with different PCIe devices and generations. Plugging in a lower lane count device/expansion card (e.g., x4/8 storage device) into a higher lane count slot (e.g., x16 GPU, NIC specific slot) allows the device to work as intended, although with the cumulative bandwidth of the slowest component. Because an x4/8 storage device will only use the first four or eight lanes of a slot optimized for NIC or GPUs (e.g., x16), the slot wastes connectivity to the PCIe root complex by not fully being used for storage.

Likewise, a higher lane count device/expansion card (e.g., x16 GPU or NIC) may be plugged into a small lane count slot (e.g., x4/8 storage-specific slot) as long as it can fit, but the configuration will work at the lowest expected speed between the slot and the device. Therefore, an x16 NIC or GPU card may be plugged into an x4/8 expansion slot optimized for storage, but this slot would not be able to support the bandwidth needed by a NIC or GPU.

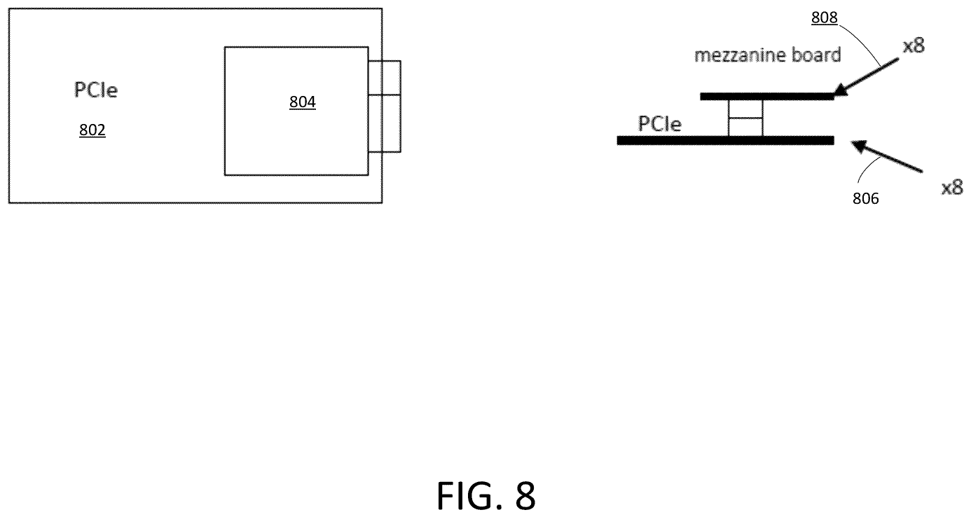

In addition to the problems associated with cross and backward compatibility, there is also a need to connect separate physical computer chassis with larger numbers of PCIe lanes. The present PCIe slot adaption method addresses these issues. In some embodiments, the present method allows a drive slot (E3.S slot) to be adapted for use as another drive type. In some embodiments, the present method may increase the lane width when fitting a higher lane count device/expansion card (e.g., NIC, GPU) to a small lane count slot (e.g., storage-focused expansion slot, E3.S slot) of a baseboard. In some embodiments, the present disclosure also describes one or more novel adaptors designed to implement the present PCIe slot adaption method, as shown in FIGS. 8-10.

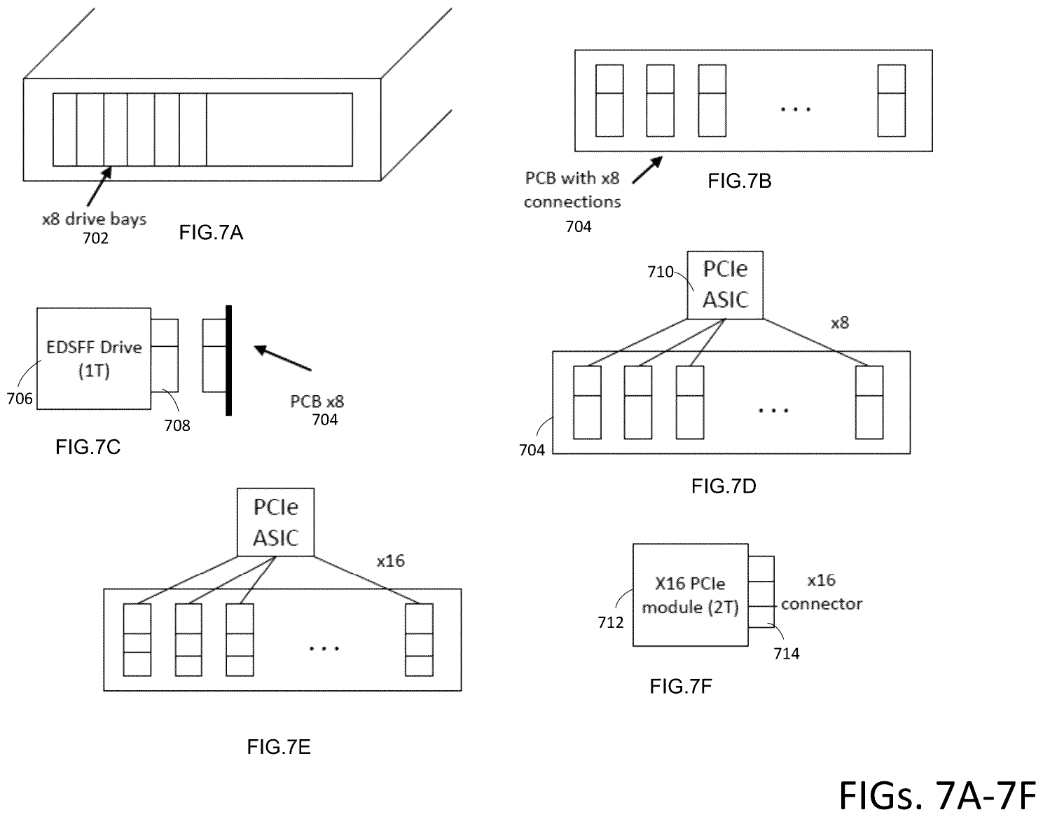

FIGS. 7A-7F illustrate block diagrams of an exemplary computer system with multiple PCIe slots and connectivity to the computer system via the PCIe slots. FIG. 7A illustrates an exemplary computer system with multiple PCIe slots. Each slot has 8 lanes and is stored on a x8 drive bay 702. In this example, the slots are designed to be used with E3 form factor EDSFF drives. The E3 form factor has two lengths: short and long or “.S” and “.L.” E3 also has two widths, 1T and 2T. 2T (thick) is one nominally twice as wide as 1T (thin). In some embodiments, the present system takes advantage of E3.S 2T for slot adaptation.

FIG. 7B illustrates an exemplary computer system PCB with multiple eight-lane PCIe connectors 704, according to some embodiments. FIG. 7C illustrates an EDSFF drive 706 and its connection to a PCB (e.g., as shown in FIG. 7B). In particular, FIG. 7C shows how the connectors 708 of EDSFF drive 706 can relate to the connectors on the computer system PCB (e.g., 704). EDSFF drives 706 used for storage are usually 1T devices, as depicted.

FIG. 7D shows an example of the connectivity of a computer system with eight lanes to each PCI slot (e.g., 704 in FIG. 7B). The PCIe links in FIG. 7D come from a PCIe switch 710. The PCIe switch is one of the components (e.g., physical size, available pins, power, cost, PCB routing channels, and other components) that restrict the total number of ports or lanes that can be supported as discussed above.

FIG. 7E shows an example of the connectivity of a computer system with 16 lanes to each PCIe slot. FIG. 7F shows a 16-lane (x16) E3 form factor device 712 and its connector 714. This device 712 is 2T. Accommodating both 8-lane (x8) storage devices and the thicker 16-lane (x16) devices requires over-provisioning the slots with lanes (i.e., x16), which is not space, cost, or power efficient.

FIG. 8 illustrates a block diagram of a PCIe slot adaptor of the present system, according to some embodiments. The PCIe slot adaptor is a 2T form factor device. This device consists of a base board 802 that plugs into (i.e., mechanically and electrically couples to) the first connector of a slot pair, as shown in 806. Base board 802 comprises a daughter board 804 with a mezzanine or other type of connectivity. Daughter board 804 can plug into the second connector of the slot pair, as shown in 808. In this way, the base board 802 has access to all 16 lanes for the PCIe function (e.g., NIC, GPU) implemented in the system. The present adaptor therefore offers an efficient solution to extend the usability of a low lane count slot (i.e., x8) to a high lane count device/expansion card (e.g., x16), without bandwidth limitation for the high lane count device.

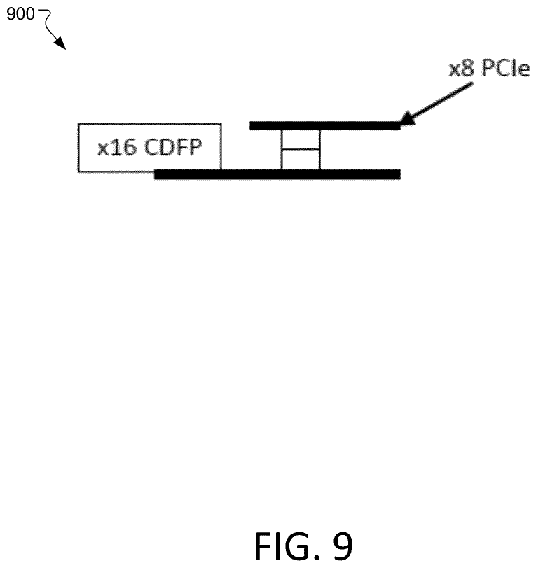

FIG. 9 illustrates an example 900 of a PCIe function, where a connector can provide connectivity to another chassis via PCIe. CDFP is a form factor used for this PCIe function. There may be PCIe retimers or other additional components.

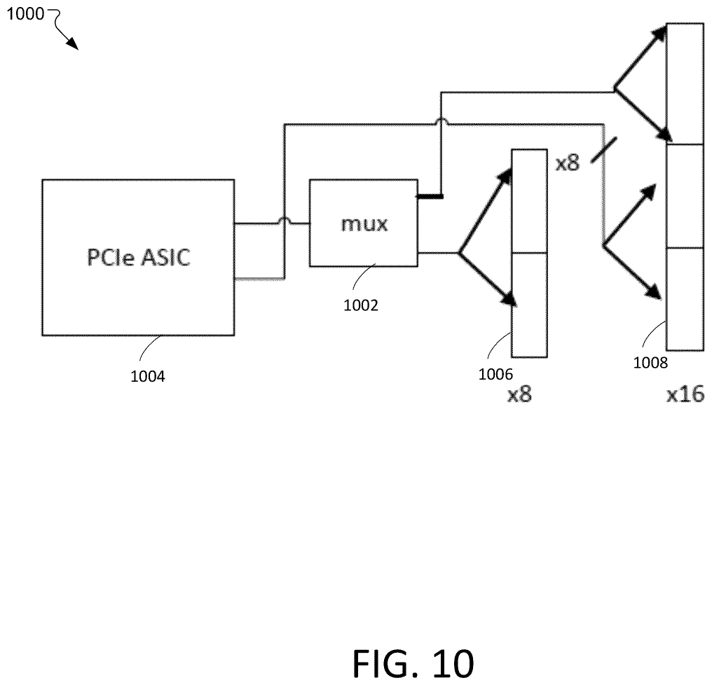

FIG. 10 illustrates a block diagram 1000 of a PCIe slot adaptation device of the present system, according to other embodiments. As depicted, a mux/demux device 1002, which is connected to the system-side PCIe device 1004, may act as a PCIe slot adaptation device. The lanes from mux/demux 1002 can either go to the first connector 1006 in a slot pair as additional lanes, or go to the second connector 1008 in the slot pair as an additional port in the system. In some embodiments, a software function may be used to control the state of mux/demux 1002 based on the presence detect pins of the inserted device or other indications.

### Flowcharts of Modular Interconnection System

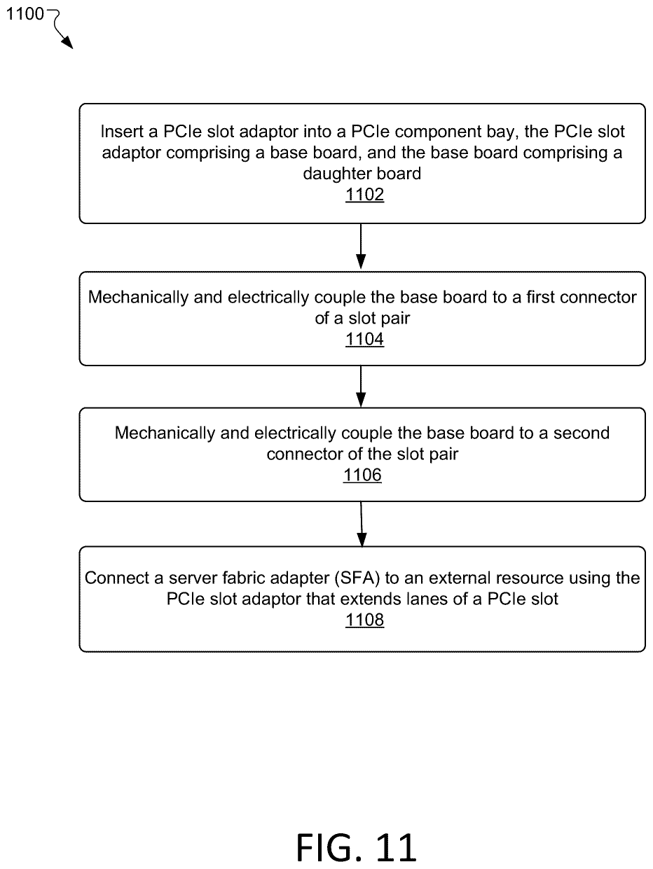

FIG. 11 illustrates an exemplary process 1100 for PCIe slot adaption, according to some embodiments. In some embodiments, a modular interconnection system includes at least one SFA configured to perform peripheral PCIe/CXL interconnection. Multiple ports on one or more PCIe slots may be configured to connect the SFA to external resources, and a PCIe slot adaptation device may be configured to adapt a first lane count slot of the one or more PCIe slots to support a second lane count device without limiting the bandwidth required by the second lane count device.

At step 1102, a PCIe slot adaptor is inserted into a PCIe component bay. In some embodiments, the PCIe slot adaptor includes a base board, and the base board includes a daughter board.

At step 1104, the base board is mechanically and electrically coupled to a first connector of a slot pair. At step 1106, the base board is mechanically and electrically coupled to a second connector of the slot pair. As a result, the base board has access to all lanes associated with both the first and second connectors.

At step 1108, an SFA is connected to an external resource using the PCIe slot adaptor that extends the lanes of a PCIe slot.

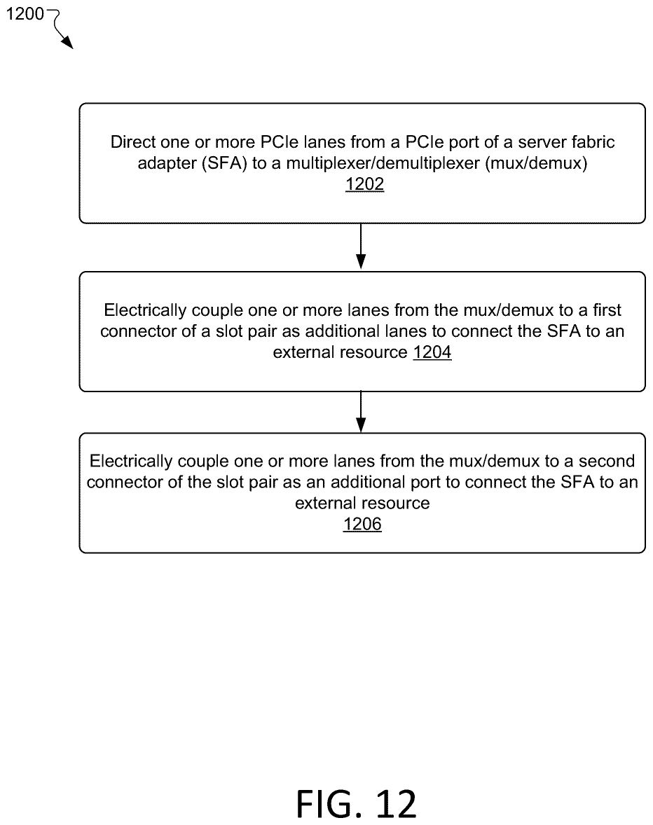

FIG. 12 illustrates an exemplary process 1200 for PCIe slot adaption, according to other embodiments. At step 1202, one or more PCIe lanes from a PCIe port of an SFA are directed to a mux/demux. At step 1204, one or more lanes from the mux/demux are electrically coupled to a first connector of a slot pair as additional lanes to connect the SFA to an external resource. At step 1206, one or more lanes from the mux/demux may also be electrically coupled to a second connector of the slot pair as an additional port to connect the SFA to an external resource.

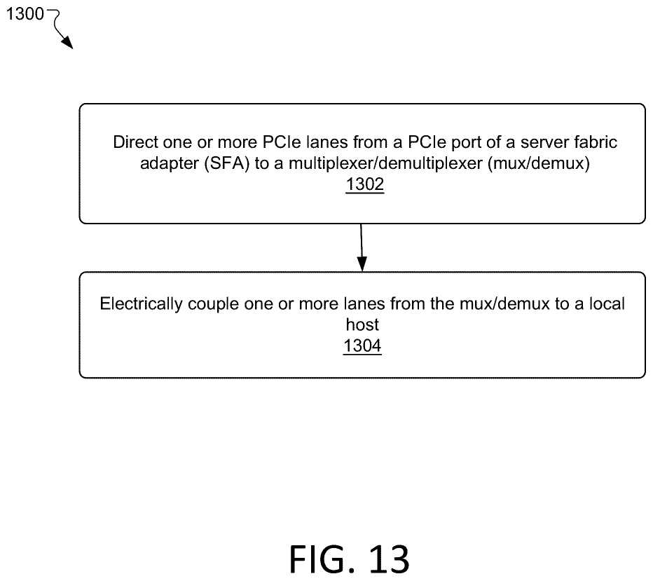

FIG. 13 illustrates an exemplary process 1300 for connecting a local host to an SFA, according to some embodiments. At step 1302, one or more peripheral component interconnect express (PCIe) lanes from a PCIe port of the SFA to a mux/demux. At step 1304, one or more lanes from the mux/demux are electrically coupled to the local host. As a result, the SFA is connected to the SFA via the mux/demux.

### ADDITIONAL CONSIDERATIONS

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 830 may be implemented in a distributed way over a network, for example as a server farm or a set of widely distributed servers, or may be implemented in a single computing device.

Although an example processing system has been described, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying FIG. s do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A modular interconnection system comprising:
a server fabric adapter (SFA) on a primary circuit board, the SFA configured to perform peripheral component interconnect express (PCIe) interconnection or compute express link (CXL) interconnection;
a plurality of ports on one or more PCIe slots configured to connect the SFA to external resources; and
a PCIe slot adaptation device configured to adapt a first lane count slot of the one or more PCIe slots to support a second lane count device.

2. The system of claim 1, wherein the external resources comprise one or more of non-volatile memory express (NVMe) drives, network interface cards (NICs), or graphics processing units (GPUs).

3. The system of claim 1, wherein the first lane count is lower than the second lane count, and the PCIe slot adaptation device is further configured to add lanes of bandwidth to meet requirement of the second lane count device.

4. The system of claim 3, wherein the first lane count slot is a four-lane or eight-lane slot, and the second lane count device is a 16-lane device.

5. The system of claim 4, wherein the first lane count slot is a storage specific slot, and the second lane count device is a GPU or NIC.

6. The system of claim 3, wherein the PCIe slot adaptation device is a PCIe slot adaptor configured to adapt the low first lane count drive slot for use as a second drive type.

7. The system of claim 6, wherein the first lane count slot is an E3 short (E3.S) slot, and the PCIe slot adaptor is a 2T form factor device.

8. The system of claim 6, wherein:
the PCIe slot adaptor comprises a base board,
the base board comprises a daughter board,
the base board is configured to plug into a first connector of a slot pair,
the daughter board is configured to plug into a second connector of the slot pair, and
the base board has access to all lanes associated with both the first and second connectors.

9. The system of claim 6, wherein the base board is used to perform a PCIe function of being a connector to provide connectivity to a separate physical computer chassis via PCIe, and the separate chassis is connected with all the PCIe lanes associated with both the first and second connectors.

10. The system of claim 1, wherein the PCIe slot adaptation device is a multiplexer/demultiplexer (mux/demux), the mux/demux is configured to plug into a first connector of a slot pair as additional lanes or plug into a second connector of the slot pair as an additional port.

11. The system of claim 10, wherein a software function is used to control a state of the mux/demux.

12. The system of claim 1, wherein the SFA is further configured to connect to a local host via a mux/demux, wherein the local host resides on a separate circuit board.

13. The system of claim 12, further comprising a second SFA residing on a second circuit board, the second SFA configured to connect to the local host.

14. The system of claim 1, further comprising one or more SFAs residing on the primary circuit board, wherein a portion of the plurality of ports associated with each SFA is on the primary circuit board and the rest of the ports associated with the SFA are on a second circuit board.

15. The system of claim 14, wherein the second circuit board is one of storage based mezzanine cards.

16. The system of claim 15, wherein each of the storage based mezzanine cards includes one or more enterprise and datacenter standard form factor (EDSFF) drives and/or one or more CD form factor pluggable (CDFP) modules.

17. A peripheral component interconnect express (PCIe) slot adaption method comprising:
inserting a PCIe slot adaptor into a PCIe component bay, the PCIe slot adaptor comprising a base board, and the base board comprising a daughter board;
mechanically and electrically coupling the base board to a first connector of a slot pair;
mechanically and electrically coupling the base board to a second connector of the slot pair; and
connecting a server fabric adapter (SFA) to an external resource using the PCIe slot adaptor that extends lanes of a PCIe slot.

18. The method of claim 17, wherein the base board has access to all lanes associated with both the first and second connectors.

19. A peripheral component interconnect express (PCIe) slot adaption method comprising:
directing one or more PCIe lanes from a PCIe port of a server fabric adapter (SFA) to a multiplexer/demultiplexer (mux/demux); and
electrically coupling one or more lanes from the mux/demux to a first connector of a slot pair as additional lanes to connect the SFA to an external resource.

20. The method of claim 19, further comprising electrically coupling one or more lanes from the mux/demux to a second connector of the slot pair as an additional port to connect the SFA to an external resource.

21. A method for connecting a local host to a server fabric adapter (SFA), the method comprising:
directing one or more peripheral component interconnect express (PCIe) lanes from a PCIe port of a server fabric adapter (SFA) to a multiplexer/demultiplexer (mux/demux); and
electrically coupling one or more lanes from the mux/demux to the local host.
